(19) United States
(12) Patent Application Publication
(10) Pub. No.: US 2009/0303917 A1
(43) Pub. Date: Dec. 10, 2009

(54) COMMUNICATION SYSTEM, COMMUNICATION APPARATUS, AND LINK USE STOPPING METHOD

(75) Inventor: Koji Nakata, Aichi (JP)

Correspondence Address: HOGAN & HARTSON L.L.P., 1999 AVENUE OF THE STARS, SUITE 1400, LOS ANGELES, CA, 90067, US

(73) Assignee: Kyocera Corporation, Kyoto (JP)

(21) Appl. No.: 11/995,085

(22) PCT Filed: Jul. 3, 2006
(86) PCT No.: PCT/JP2006/313212

§ 371 Date: Mar. 18, 2009

(30) Foreign Application Priority Data
Jul. 12, 2005 (JP) 2005-203724

(51) Int. Cl. H04B 7/14

(52) U.S. Cl. 370/315

(57) ABSTRACT

Resources for maintaining links are conserved by not using links that substantially cannot relay data.

In a mobile communication system (10) for multilink communication in which a mobile station apparatus (20) carries out communication using a plurality of links, each of the links is a link relayed by respective base station apparatuses (30). Each base station apparatus (30) sends bandwidth information indicating the bandwidth that can be allocated by the base station apparatus (30) to the mobile station apparatus (20), and the mobile station apparatus (20) receives the bandwidth information that has been sent and stops use of the respective links based on the received bandwidth information.

### TECHNICAL FIELD

The present invention relates to a communication system, communication apparatus, and link use stopping method.

### BACKGROUND ART

In multilink communication in which communication is performed using a plurality of links simultaneously, a communication apparatus establishes a link before communication is initiated, and disestablishes the link when communication has ended or when the communication line is disconnected.

The communication links between communication apparatuses are often relayed by relay communication apparatuses. An example of a relay communication apparatus is a router or base station apparatus. Routers relay communication between computers, and base station apparatuses relay communication between mobile station apparatuses and server apparatuses.

Patent document 1 discloses a technology related to a method for establishing a link in a wireless communication terminal.

[Patent Document 1] Japanese Laid-open Patent Application No. 2004-153790

### DISCLOSURE OF THE INVENTION

### Problems to be Solved by the Invention

Such a relay communication apparatus relays a plurality of communications through each link. For this reason, the bandwidth that the relay communication apparatus can allocate to each individual communication apparatus decreases depending on the amount of data that must be relayed. As a result, an established link may still become substantially incapable of relaying data despite the fact that the line is not yet disconnected.

However, in conventional communication apparatuses for performing multilink communication, links via which data substantially cannot be relayed, as described above, are established even when communication can occur via other links. Therefore, resources for preserving the link (memory areas and CPU time) are consumed.

Consequently, it is an object of the present invention to provide a communication system, communication apparatus, and link use stopping method whereby it is possible to conserve resources for preserving links by not using links via which data relay substantially cannot be performed during multilink communication.

### Means for Solving the Problems

In order to resolve the above problems, the communication system pertaining to the present invention is a communication system in which a communication apparatus performs multilink communication using a plurality of links, the communication system being characterized in that: each of the links is a link relayed by respective relay communication apparatuses; each of the respective relay communication apparatuses comprises transmission means for transmitting bandwidth information that indicates a bandwidth that the relay communication apparatus can allocate to the communication apparatus; and the communication apparatus comprises: receiving means for receiving the bandwidth information that has been transmitted; and use stopping means for stopping a use of each of the links based on the bandwidth information that has been received.

According to this arrangement, the communication apparatus can stop use of a link routed through a relay communication apparatus based on the bandwidth that the relay communication apparatus can allocate to the communication apparatus. When multilink communication is carried out, it is thus possible to conserve resources for maintaining links by not using links that substantially cannot relay data due to insufficient bandwidth.

In addition, in the above communication system, the use stopping means may stop use of links in which the bandwidth indicated by the received bandwidth information is below a predetermined value.

In addition, in the above communication system, the use stopping means stops use of each of the links based on a state of other links used by the communication apparatus.

In addition, the communication apparatus pertaining to the present invention is a communication apparatus performing multilink communication using a plurality of links relayed by respective relay communication apparatuses, the communication apparatus being characterized in comprising: receiving means for receiving bandwidth information indicating a bandwidth that the relay communication apparatus can allocate to the communication apparatus from each of the respective relay communication apparatuses; and use stopping means for stopping use of each of the links based on the bandwidth information that has been received.

The link use stopping method pertaining to the present invention is a link use stopping method stopping a use of a link in a communication system in which a communication apparatus performs multilink communication using a plurality of links relayed by respective relay communication apparatuses, the link use stopping method being characterized in comprising: an acquisition step for acquiring bandwidth information indicating a bandwidth that can be allocated by the relay communication apparatuses to the communication apparatus; and a use stopping step for stopping a use of each of the links based on the bandwidth information that has been acquired.

### BRIEF DESCRIPTION OF THE DRAWINGS

FIG. 1 is a schematic view of a mobile communications system pertaining to an embodiment of the present invention;

FIG. 2 is a configuration diagram of a mobile station apparatus pertaining to the embodiment of the present invention;

FIG. 3 is a view of a base station apparatus pertaining to the embodiment of the present invention;

FIG. 4 is a configuration diagram of a server apparatus pertaining to the embodiment of the present invention;

FIG. 5 is a functional block diagram of a base station apparatus and mobile station apparatus pertaining to the embodiment of the present invention; and

FIG. 6 is a process flow chart pertaining to the embodiment of the present invention.

### BEST MODE FOR CARRYING OUT THE INVENTION

An embodiment of the present invention will be described with reference to the accompanying drawings.

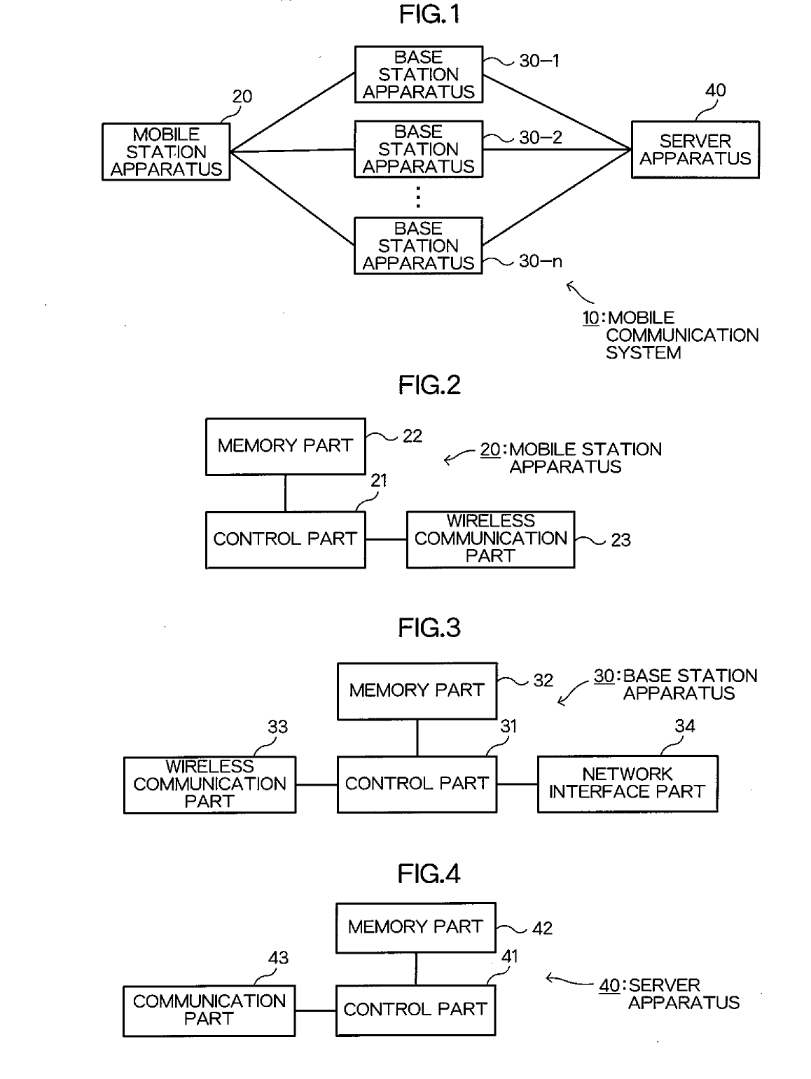

A mobile communication system 10 pertaining to the embodiment, as shown in FIG. 1, consists of a mobile station apparatus 20, a plurality of base station apparatuses 30, and a server apparatus 40, where the mobile station apparatus 20 and server apparatus 40 are connected via the base station apparatuses 30 and communication pathways (links).

The mobile station apparatus 20, as shown in FIG. 2, comprises a control part 21, a memory part 22, and a wireless communication part 23. The control part 21 controls each part of the mobile station apparatus 20 and executes processes related to conversation and data communication. The memory part 22 functions as a work memory for the control part 21. This memory part 22 also stores parameters and programs related to the various processes carried out by the control part 21 and stores the program pertaining to the present invention as well. The wireless communication part 23 has an antenna and a wave detection device and carries out processes according to instructions input from the control part 21 whereby voice signals, communication packets, and the like are modulated and output via the antenna. In addition, the wireless communication part 23 carries out processes involving receiving, demodulating, and outputting to the control part 21 voice signals, communication packets, and the like arriving on the antenna.

The wireless communication part 23 simultaneously utilizes a plurality of links for a single communication and specifically carries out communication via a plurality of base station apparatuses 30. The control part 21 sets the volume ratios for the data transmitted on each link when a plurality of links is used in this manner.

In addition, the memory part 22 stores physical communication resources such as frequencies and time slots correspondingly with the links, and, when communication data are transmitted, the wireless communication part 23 reads the physical communication resources that are stored correspondingly with the links via which the communication data are transmitted, and then transmits using the communication resources that have been read.

The base station apparatus 30, as shown in FIG. 3, comprises a control part 31, a memory part 32, a wireless communication part 33, and a network interface part 34. The control part 31 controls each part of the base station apparatus 30 and executes processes related to conversations and data communication. The memory part 32 acts as a work memory for the control part 31. In addition, this memory part 32 stores parameters and programs related to each of the processes carried out by the control part 31 and also stores programs related to the present invention. The wireless communication part 33 has an antenna and a wave detection device and carries out processes whereby voice signals, communication packets, and the like are each received from at least one mobile station apparatus 20, demodulated, and output to the control part 31. The wireless communication part 33 also carries out processes whereby, in accordance with instructions input from the control part 31, voice signals, communication packets, and the like input from the control part 31 are modulated and output via the antenna. The network interface part 34 is connected to a communications network (not shown) and carries out processes involving receiving voice signals, communication packets, and the like from the server apparatus 40 connected to the communications network, and outputting these to the control part 31. In addition, the network interface part 34 also carries out processes whereby, in accordance with instructions from the control part 31, voice signals, communication packets, and the like are sent to the server apparatus 40 that is connected to the communications network.

The base station apparatus 30 transmits signals received from the mobile station apparatus 20 to the server apparatus 40 and sends signals received from the server apparatus 40 to the mobile station apparatus 20. In this manner, the base station apparatus 30 functions as a relay communication apparatus that relays communication carried out between the mobile station apparatus 20 and the server apparatus 40.

In addition, the memory part 32 stores physical communication resources such as communications ports, frequencies, and time slots correspondingly with the links. When communication data is to be sent, the wireless communication part 33 or network interface part 34 reads, from the memory part 32, the stored physical communication resources corresponding to the link on which the communication data is to be sent and performs a transmission using the communication resources that have been read.

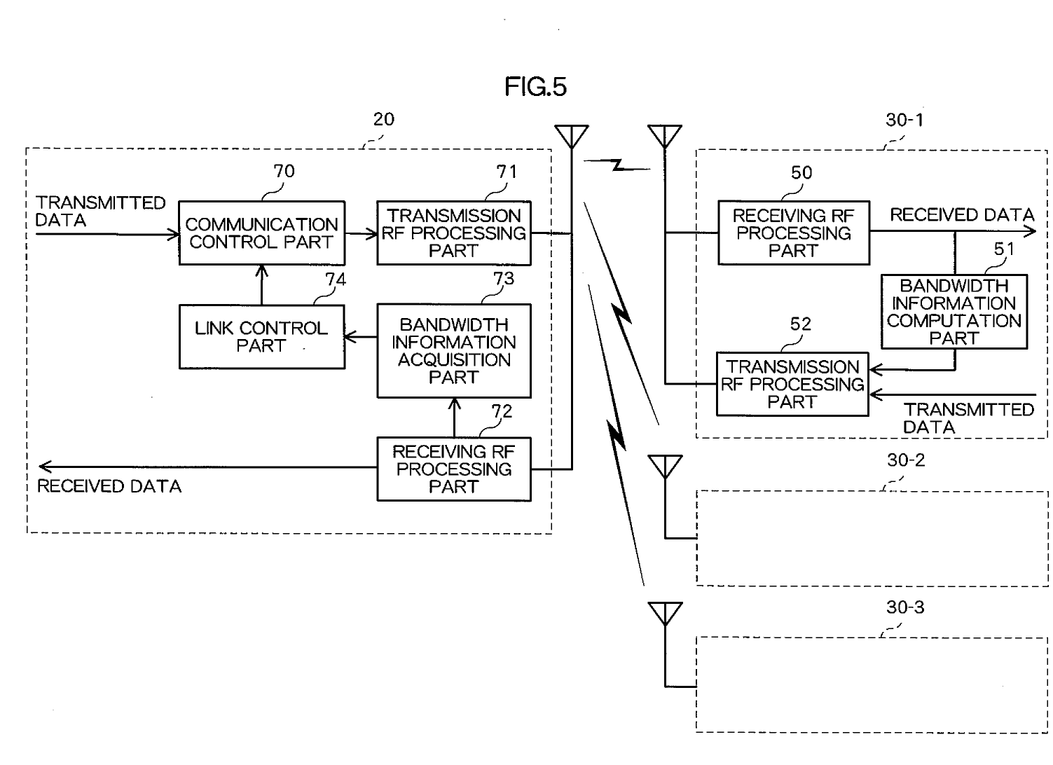

The server apparatus 40, as shown in FIG. 4, comprises a control part 41, a memory part 42, and a communication part 43. A telephone exchange, personal computer, workstation, mainframe, or other computer is preferably used for the server apparatus 40. The control part 41 controls each part of the server apparatus 40 and executes processes related to data communication and various types of data processes. In addition, the control part 41 carries out processes whereby the results of the processing are displayed on display means (not shown) In addition, the control part 41 receives input from input means (not shown) and carries out processes in accordance with this input. The memory part 42 operates as a work memory for the control part 41. In addition, this memory part 42 stores parameters and programs related to the various processes carried out by the control part 41 and also stores programs pertaining to the present invention. The communication part 43 is connected to a communication network (not shown) and is connected with a plurality of base station apparatuses 30 via the communication network.

The communication part 43 carries out communication via a plurality of base station apparatuses 30 using a plurality of links simultaneously for a single communication. The control part 41 determines the ratio of data volume to be transmitted for each link in cases where a plurality of links is used simultaneously in this manner.

In addition, the memory part 42 stores physical communication resources such as the communication ports correspondingly with the links. During transmission of communication data, the communication part 43 reads, from the memory part 42, the physical communication resources stored correspondingly with the link via which the communication data is to be sent and transmits the communication resources that have been read.

In the present embodiment, the mobile station apparatus 20 and server apparatus 40 carry out a single communication using each of the plurality of links simultaneously, in the manner described above. The communication format whereby the plurality of links is used simultaneously in a single communication in this manner is referred to as multilink communication.

In this embodiment, the base station apparatus 30 acquires bandwidth information representing the bandwidth that can be allocated to the mobile station apparatus 20 for the link that is relayed by the base station apparatus 30, and sends this bandwidth information to the mobile station apparatus 20. The mobile station apparatus 20 carries out the link use stopping process in accordance with the bandwidth information. The configurations and processes for such a purpose are described in detail below.

FIG. 5 is a functional block diagram showing functional blocks for the mobile station apparatus 20 and base station apparatus 30. As shown in the drawings, the base station apparatus 30, from a functional standpoint, comprises a receiving RF processing part 50, a bandwidth information computation part 51, and a transmission RF processing part 52. In addition, the mobile station apparatus 20, from a functional standpoint, comprises a transmission control part 70, a transmission RF processing part 71, a receiving RF processing part 72, a bandwidth information volume acquisition part 73, and a link control part 74.

The receiving RF processing part 50 receives wireless signals sent from each of the mobile station apparatuses 20. The receiving RF processing part 50 demodulates the received wireless signals, acquires the communication data, and sends the data to the server apparatus 40.

The communication RF processing part 52 transmits, to the mobile station apparatus 20, the communication data received by the receiving part (not shown) from the server apparatus 40.

The bandwidth information computation part 51 acquires wireless bandwidth information based on the wireless signals (uplink wireless signals) from each of the mobile station apparatuses 20 received by the receiving RF processing part 50. This wireless bandwidth information is information that shows the communication surplus in the wireless region, specifically, the number of communications in the wireless region. Next, the bandwidth information computation part 51 computes the bandwidth information based on the acquired wireless bandwidth information. The bandwidth information computation part 51 then outputs the computed bandwidth information to the transmission RF processing part 52. The transmission RF processing part 52 transmits the input bandwidth information to the mobile station apparatus 20.

The process for computing the bandwidth information shall be discussed in detail hereunder. In the computation process described below, each of the base station apparatuses 30 is designed to compute the bandwidth information with the bandwidth information classified according to a plurality of stages (in this case, S stages from stage 1 to stage S). Specifically, the base station apparatus 30 stores detailed bandwidth information values corresponding to each stage. The base station apparatus 30 first computes the stage to which the bandwidth information belongs, and the specific values corresponding to the computed stage are taken as the bandwidth information.

Each of the base station apparatuses 30 first acquires the number of mobile station apparatuses 20 that are communicating using the same frequency as the mobile station apparatus 20 that is attempting to compute the bandwidth information (the number of mobile station apparatuses that are involved in communication). Next, the bandwidth information is computed based on the number of mobile station apparatuses that are involved in communication. Specifically, when the number of mobile station apparatuses involved in communication is n, then formula I below can be used in order to determine the stage D to which the bandwidth information corresponding to the number of mobile station apparatuses involved in communication belongs. In the formula, the brackets denote Gaussian marks, which are marks that indicate rounding to the decimal place of X or less. Thus, if n≦X≦n+1, then [X]=n.

D=[S/n] (1)

Each of the base station apparatuses 30 transmits bandwidth information computed by the bandwidth information computation part 15 in the manner above to the mobile station apparatus 20.

The receiving RF processing part 72 receives information data received from the base station apparatus 30 and issues an output as received data to a communication processing part not shown in the figure. A bandwidth information acquisition part 73 acquires bandwidth information contained in the communication data that is output to the communication processing part using the receiving RF processing part 72.

The link control part 74 determines whether use is to be stopped for each of the links based on the bandwidth information acquired by the bandwidth information acquisition part 73, and sends commands to the transmission control part 70 so that the links that are not to be used are disconnected. The transmission control part 70 disconnects the links designated to be disconnected, establishes a correspondence between the other links and the communication data to be sent by the links, and issues an output to the transmission RF processing part 71. The transmission RF processing part 71 transmits communication data to the link that has been associated with the communication data.

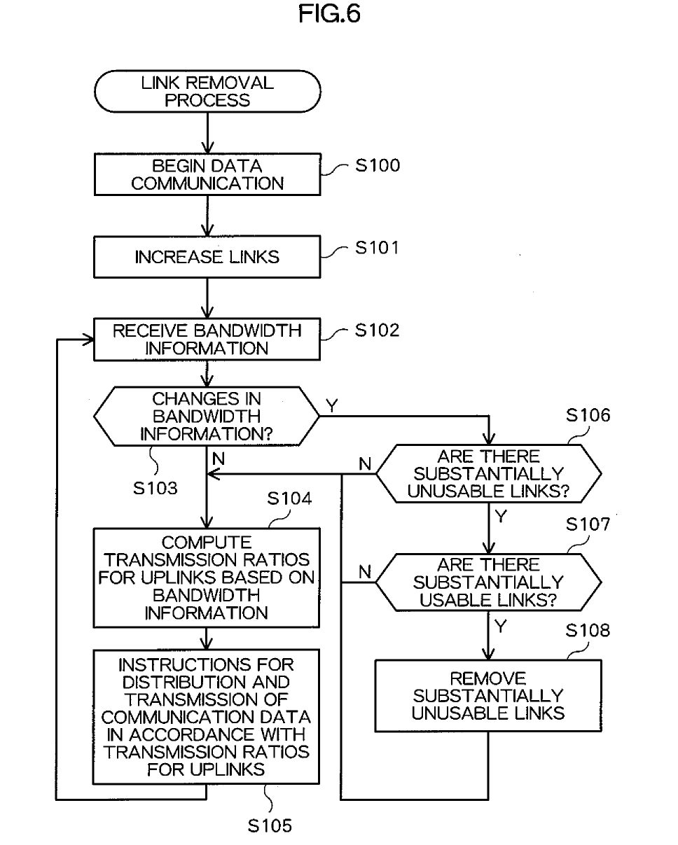

The process whereby a link is disconnected based on the bandwidth information in the mobile communications system 10 having the configuration of this type is described in reference to FIG. 6.

FIG. 6 is a flowchart of the process whereby the mobile station apparatus 20 removes a link in accordance with the bandwidth information. As is also indicated, first, the mobile station apparatus 20 initiates data communication with a server apparatus 40 (S100). Next, if multilink communication is to be carried out, then the mobile station apparatus 20 increases the number of links (S101). The mobile station apparatus 20 carries out multilink communication according to this process.

Next, the mobile station apparatus 20 receives bandwidth information from each of the base station apparatuses 30 that performs a relay via each link (S102). The mobile station apparatus 20 stores bandwidth information received from each of the base station apparatuses 30. Next, the previously stored bandwidth information and the received bandwidth information are compared and a decision is made as to whether a change has occurred in bandwidth information received from each of the base station apparatuses 30 (S103).

If it is determined in S103 that the bandwidth information has not changed, then the mobile station apparatus 20 computes the transmission ratio for each link based on the received bandwidth information (S104). Specifically, the ratios of the bandwidth allocation amounts for the base station apparatuses 30 indicated by the bandwidth information are computed, and these ratios are used as transmission ratios for each of the links. The mobile station apparatus 20 then issues an instruction to the transmission control part 70 so that communication data volumes are distributed and sent on each link in the ratios corresponding to the computed transmission ratios for each of the links (S105).

If it is determined in S103 that the bandwidth information has changed, then the mobile station apparatus 20 determines whether or not there is a link that is substantially unused (S106). Specifically, the mobile station apparatus 20 determines whether there is a link in which the bandwidth allocation amount represented by the bandwidth information is below a predetermined value. Links in which the value is below a predetermined value are judged to be links that are substantially unable to transmit data, and a decision is made to stop use.

Next, the mobile station apparatus 20 determines whether there is a link that is substantially usable (S107). Specifically, the mobile station apparatus 20 determines whether there is a link in which the bandwidth allocation volume represented by the bandwidth information is above a predetermined value. If there is a link with a value that is above this value, then it is determined that there is a link that is substantially usable. When it is determined that there is a link that is substantially usable, the mobile station apparatus 20 instructs the transmission control part 70 to disconnect (remove) links for which the stop use decision has been made (S108). Meanwhile, the mobile station apparatus 20 transmits information data in accordance with the process of S104 if a determination has been made in S106 that there are no links that are substantially not usable, and if a determination has been made in S107 that there are no links that are substantially usable. The mobile station apparatus 20 repeats these processes until the communication initiated in S100 has been completed.

The mobile station apparatus can accordingly stop the use of links that go through the base station apparatus based on the bandwidth that can be allocated to the mobile station apparatus by the base station apparatus. For this reason, when multilink communication is to be carried out, it is possible to conserve resources used for maintaining links by not using links that substantially cannot relay data due to insufficient bandwidth. In addition, the mobile station apparatus recognizes the state of the other links and removes links only when there are links that substantially can be used, so that links can be efficiently utilized during multilink communication.

The present invention is not limited to the above embodiment. For example, in the above embodiment, bandwidth information is computed by the base station apparatus based on the number of mobile station apparatuses involved in communication, but can also be computed based on, for example, the modulation format for communication carried out between mobile station apparatuses (e.g., QPSK and 16QAM; an uplink modulation format is particularly preferred, but either uplink or downlink formats may be used) or FER (frame error rate) prediction values (uplink or downlink formats may be employed, but an uplink modulation format is particularly preferred).

In other words, the modulation format reflects the data fate (communication speed), and the bandwidth allocation volume can be understood to increase with increasing communication speed. In this manner, there is a correspondence between modulation format and bandwidth information, and the base station apparatus can compute bandwidth information based on the modulation format. Moreover, when the FER is poor, the bandwidth allocation volume substantially decreases due to resend restrictions. In this manner, there is a correspondence between the bandwidth allocation volume and FER, and the base station apparatus can compute the bandwidth information based on the FER.

In the above embodiment, link removal processing is carried out at the mobile station apparatus, but a similar process can be carried out at the server apparatus. It is possible to realize this type of mode through transmission of bandwidth information to the server apparatus from the base station apparatus.

The present invention can be applied to any communication system that involves multilink communication, not merely in mobile communication systems.

1. A communication system in which a communication apparatus performs multilink communication using a plurality of links, the communication system being characterized in that:
each of the links is a link relayed by respective relay communication apparatuses;
each of the respective relay communication apparatuses comprises transmission means for transmitting bandwidth information that indicates a bandwidth that the relay communication apparatus can allocate to the communication apparatus; and
the communication apparatus comprises:
receiving means for receiving the bandwidth information that has been transmitted; and
use stopping means for stopping a use of each of the links based on the bandwidth information that has been received.

2. The communication system according to claim 1, which is characterized in that:
the use stopping means stops use of links in which the bandwidth indicated by the received bandwidth information is below a predetermined value.

3. The communication system according to claim 1 or 2, which is characterized in that:
the use stopping means stops use of each of the links based on a state of other links used by the communication apparatus.

4. A communication apparatus performing multilink communication using a plurality of links relayed by respective relay communication apparatuses, the communication apparatus being characterized in comprising:
receiving means for receiving bandwidth information indicating a bandwidth that the relay communication apparatus can allocate to the communication apparatus from each of the respective relay communication apparatuses; and
use stopping means for stopping use of each of the links based on the bandwidth information that has been received.

5. A link use stopping method stopping a use of a link in a communication system in which a communication apparatus performs multilink communication using a plurality of links relayed by respective relay communication apparatuses,
the link use stopping method being characterized in comprising:
an acquisition step for acquiring bandwidth information indicating a bandwidth that can be allocated by the relay communication apparatuses to the communication apparatus; and
a use stopping step for stopping a use of each of the links based on the bandwidth information that has been acquired.
